(19) United States
(12) Patent Application Publication
(10) Pub. No.: US 2025/0214807 A1
(43) Pub. Date: Jul. 3, 2025

(54) ELEVATOR CALL ALLOCATION WITH ADAPTIVE MULTI-OBJECTIVE OPTIMIZATION

(71) Applicant: KONE Corporation, Helsinki (FI)

(72) Inventors: Janne Sorsa, Helsinki (FI); Juha-Matti Kuusinen, Helsinki (FI); Mirko Ruokokoski, Helsinki (FI); Johan Backlund, Helsinki (FI); Juho KOKKALA, Helsinki (FI); Anton GLAD, Helsinki (FI)

(73) Assignee: KONE Corporation, Helsinki (FI)

(21) Appl. No.: 19/083,599

(22) Filed: Mar. 19, 2025

Related U.S. Application Data
(63) Continuation of application No. PCT/EP2022/077789, filed on Oct. 6, 2022.

(51) Int. Cl. B66B 1/24

(52) U.S. Cl. CPC B66B 1/2408; B66B 2201/211; B66B 2201/212; B66B 2201/215; B66B 2201/216; B66B 2201/22; B66B 2201/403; B66B 2201/404

(57) ABSTRACT

Apparatuses, methods and computer programs for elevator call allocation with adaptive multi-objective optimization are disclosed. At least some of the disclosed embodiments may allow adaptively and smoothly changing an objective function according to passenger traffic. This in turn may allow minimizing waiting times in all traffic situations compared to using a fixed objective function. Furthermore, at least some of the disclosed embodiments may allow adaptively and smoothly changing the objective function according to the traffic while taking user preferences into consideration via a single transit time target parameter.

### TECHNICAL FIELD

The present disclosure relates to the field of elevators, and, more particularly, to elevator call allocation with adaptive multi-objective optimization.

### BACKGROUND

In a conventional elevator control with up and down call buttons, elevators of a group may be controlled, e.g., so that an average call time is as short as possible.

In a destination control system, call giving devices may be equipped with keypads or touchscreens and a passenger orders an elevator ride by giving their destination floor on the call giving device. This additional destination floor information allows an elevator group controller to consider and optimize other objectives related to the passenger service level in addition to a waiting time, such a to as time destination, how long the passenger journey takes in total, including a waiting time at an arrival floor and a transit time in a serving elevator to the moment the passenger exits the elevator at a destination floor.

Traditionally, a goal of an elevator group controller is to control a group of elevators so that an average waiting time of passengers is as short as possible. However, since the elevator group controller cannot see passengers arriving in the future, strictly minimizing waiting times of existing passengers in call allocation may not always be the best way to minimize actual waiting times of all passengers. Especially during heavy traffic in destination control systems, a pure time to destination objective may lead to a shorter waiting than a pure waiting time objective since the time to destination objective may provide a larger handling capacity. For example, a group controller with a waiting time objective may saturate for lighter traffic sooner than with a time to destination objective.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an object of the present disclosure to allow elevator call allocation with adaptive multi-objective optimization. The foregoing and other objects are achieved by the features of the independent claims. Further implementation forms are apparent from the dependent claims, the description and the figures.

According to a first aspect of the disclosure, an apparatus for elevator call allocation in an elevator group of an elevator system is provided. The apparatus comprises at least one processor, and at least one memory including computer program code. The at least one memory and the computer program code are configured to, with the at least one processor, cause the apparatus at least to perform obtaining at least one current passenger traffic indicator related to the elevator group. The at least one memory and the computer program code are further configured to, with the at least one processor, cause the apparatus at least to perform determining a weight for each of at least two passenger traffic optimization objectives of a passenger traffic objective function based on the obtained at least one current passenger traffic indicator. The at least one memory and the computer program code are further configured to, with the at least one processor, cause the apparatus at least to perform optimizing the passenger traffic objective function using the determined weights. The at least one memory and the computer program code are further configured to, with the at least one processor, cause the apparatus at least to perform allocating a subsequent elevator call to an elevator car in the elevator group based on a result of the optimizing traffic objective function.

In an implementation form of the first aspect, the at least two passenger traffic optimization objectives comprise a waiting time and at least one additional passenger traffic optimization objective.

In an implementation form of the first aspect, the weight for the at least one additional passenger traffic optimization objective comprises 1−ω in which ω denotes the weight for the waiting time.

In an implementation form of the first aspect, least one additional passenger traffic the at optimization objective comprises at least a time to destination.

In an implementation form of the first aspect, the at least one current passenger traffic indicator comprises a current average waiting time, AWTᵢ, and a current elevator car load factor, CLFᵢ. The obtaining of the at least one current passenger traffic indicator comprises determining a call allocation minimizing sum over passengers of at least terms ωᵢ^{e}WT_j+(1−ωᵢ^{e})TTD_j for passengers j from an entrance floor and ωᵢ^{p}WT_k+(1−ωᵢ^{p})TTD_k for passengers k from non-entrance floors, in which i denotes an elevator call allocation instance, ωᵢ^{e} denotes a weight for the entrance, e, floor, ωᵢ^{p} denotes a weight for the non-entrance, p, floors, WT denotes the waiting time, and TTD denotes the time to destination. The obtaining of the at least one current passenger traffic indicator further comprises determining the average waiting time and the elevator car load factor based on the determined call allocation minimizing sum.

In an implementation form of the first aspect, the at least one memory and the computer program code are further configured to, with the at least one processor, cause the apparatus at least to perform determining a subsequent weight ω_{*}^{e} for the entrance floor and a subsequent weight ω_{*}^{p} for the non-entrance floors. The at least one memory and the computer program code are further configured to, with the at least one processor, cause the apparatus at least to perform determining updated weights for the entrance floor and the non-entrance floors to be used in the subsequent elevator call allocation using exponential smoothing:

$${ω}_{i + 1}^{e} := {ω}_{i}^{e} δ + {ω}_{*}^{e} ( 1 - δ ) \\ {ω}_{i + 1}^{p} := {ω}_{i}^{p} δ + {ω}_{*}^{p} ( 1 - δ )$$

in which δ denotes a parameter determining how slowly the weight is changed.

In an implementation form of the first aspect, the determining of the weight for each of the at least two passenger traffic optimization objectives of the passenger traffic objective function comprises determining the weight for the waiting time for the passengers from the entrance floor based on the current average waiting time and the current elevator car load factor using a first sigmoid function:

$${ω}_{*}^{e} = min \{ {γ}_{1} ( 1 - \frac{1}{1 + {e}^{- {α}_{1} ( {AWT}_{i} - {β}_{1} )}} ) , {γ}_{2} ( 1 - \frac{1}{1 + {e}^{- {α}_{2} ( {CLF}_{i} - {β}_{2} )}} ) \} .$$

The determining of the weight for each of the at least two passenger traffic optimization objectives of the passenger traffic objective function further comprises determining the weight for the waiting time for the passengers from the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, βand γ denote parameters specifying the shape of the sigmoid functions.

In an implementation form of the first aspect, the determining of the weight for each of the at least two passenger traffic optimization objectives of the passenger traffic objective function comprises determining the weight for the waiting time for the passengers from the entrance floor and the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, β and γ denote parameters specifying the shape of the sigmoid function.

In an implementation form of the first aspect, the at least one additional passenger traffic optimization objective comprises a transit time.

In an implementation form of the first aspect, the obtaining of the at least one current passenger traffic indicator comprises determining at least one of an average transit time or an average transit time deviation after a current elevator call allocation.

In an implementation form of the first aspect, the at least one memory and the computer program code are further configured to, with the at least one processor, cause the apparatus at least to perform obtaining short-term statistics about served elevator calls to facilitate the determining of at least one of the average transit time or the average transit time deviation.

In an implementation form of the first aspect, the determining of the weight for each of the at least two passenger traffic optimization objectives of the passenger traffic objective function comprises obtaining for the waiting time for a subsequent elevator call allocation as a correction for a difference between a target transit time deviation and the determined average transit time deviation or for a difference between a target transit time and the determined average transit time.

In an implementation form of the first aspect, the at least one memory and the computer program code are further configured to, with the at least one processor, cause the apparatus to obtain the correction from a controller.

In an implementation form of the first aspect, the controller comprises a proportional-integral-derivative, PID, controller or a proportional-integral, PI, controller.

In an implementation form of the first aspect, the passenger traffic objective function comprises:

$$ω * WT + ( 1 - ω ) * TT , or \\ ω * WT + ( 1 - ω ) * TTD ,$$

in which WT denotes a sum of the waiting times, TT denotes a sum of the transit times, TTD denotes a sum of the times to destination, and ω denotes the obtained weight for the waiting time for the subsequent elevator call allocation.

In an implementation form of the first aspect, the at least one additional passenger traffic optimization objective further comprises at least one of a time to destination or a transit time, and an energy consumption.

In an implementation form of the first aspect, the at least one current passenger traffic indicator comprises at least a current average waiting time associated with a first controller configured to provide a first control signal and at least one of a current average transit time or a current average transit time deviation associated with a second controller configured to provide a second control signal. The determining of the weight for each of the at least two passenger traffic optimization objectives of the passenger traffic objective function comprises determining the weight for each of the at least two passenger traffic optimization objectives based on the first control signal and the second control signal.

According to a second aspect of the disclosure, an apparatus for elevator call allocation in an elevator group of an elevator system is provided. The apparatus comprises means for performing obtaining at least one current passenger traffic indicator related to the elevator group. The means are further configured to perform determining a weight for each of at least two passenger traffic optimization objectives of a passenger traffic objective function based on the obtained at least one current passenger traffic indicator. The means are further configured to perform optimizing the passenger objective using traffic function the determined weights. The means are further configured to perform allocating a subsequent elevator call to an elevator car in the elevator group based on a result of the optimizing of the passenger traffic objective function.

In an implementation form of the first aspect, the at least two passenger traffic optimization objectives comprise a waiting time and at least one additional passenger traffic optimization objective.

In an implementation form of the second aspect, the weight for the at least one additional passenger traffic optimization objective comprises 1−ω in which ω denotes the weight for the waiting time.

In an implementation form of the second aspect, the weight for the at least one additional passenger traffic optimization objective comprises at least a time to destination.

In an implementation form of the second aspect, the at least one current passenger traffic indicator comprises a current average waiting time, AWTᵢ, and a current elevator car load factor, CLFᵢ. The obtaining of the at least one current passenger traffic indicator comprises determining a call allocation minimizing sum over passengers of at least terms ωᵢ^{e}WT_j+(1−ωᵢ^{e})TTD_j for passengers j from an entrance floor and ωᵢ^{p}WT_k+(1−ωᵢ^{p})TTD_k for passengers k from non-entrance floors, in which i denotes an elevator call allocation instance, ωᵢ^{e} denotes a weight for the entrance, e, floor, ωᵢ^{p} denotes a weight for the non-entrance, p, floors, WT denotes the waiting time, and TTD denotes the time to destination. The obtaining of the at least one current passenger traffic indicator further comprises determining the average waiting time and the elevator car load factor based on the determined call allocation minimizing sum.

In an implementation form of the second aspect, the means are further configured to perform determining a subsequent weight ω_{*}^{e} for the entrance floor and a subsequent ω_{*}^{p} the non-entrance floors. The means are further configured to perform determining updated weights for the entrance floor and the non-entrance floors to be used in the subsequent elevator call allocation using exponential smoothing:

$${ω}_{i + 1}^{e} := {ω}_{i}^{e} δ + {ω}_{*}^{e} ( 1 - δ ) \\ {ω}_{i + 1}^{p} := {ω}_{i}^{p} δ + {ω}_{*}^{p} ( 1 - δ )$$

in which δ denotes a parameter determining how slowly the weight is changed.

In an implementation form of the second aspect, the determining of the weight for each of the at least two passenger traffic optimization objectives of the passenger traffic objective function comprises determining the weight for the waiting time for the passengers from the entrance floor based on the current average waiting time and the current elevator car load factor using a first sigmoid function:

$${ω}_{*}^{e} = min \{ {γ}_{1} ( 1 - \frac{1}{1 + {e}^{- {α}_{1} ( {AWT}_{i} - {β}_{1} )}} ) , {γ}_{2} ( 1 - \frac{1}{1 + {e}^{- {α}_{2} ( {CLF}_{i} - {β}_{2} )}} ) \} .$$

The determining of the weight for each of the at least two passenger traffic optimization objectives of the passenger traffic objective function further comprises determining the weight for the waiting time for the passengers from the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, β and γ denote parameters specifying the shape of the sigmoid functions.

In an implementation form of the second aspect, the determining of the weight for each of the at least two passenger traffic optimization objectives of the passenger traffic objective function comprises determining the weight for the waiting time for the passengers from the entrance floor and the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, β and γ denote parameters specifying the shape of the sigmoid function.

In an implementation form of the second aspect, least one the at additional passenger traffic optimization objective comprises a transit time.

In an implementation form of the second aspect, the obtaining of the at least one current passenger traffic indicator comprises determining at least one of an average transit time or an average transit time deviation after a current elevator call allocation.

In an implementation form of the second aspect, the means are further configured to perform obtaining short-term statistics about served elevator calls to facilitate the determining of at least one of the average transit time or the average transit time deviation.

In an implementation form of the second aspect, the determining of the weight for each of the at least two passenger traffic optimization objectives of the passenger traffic objective function comprises obtaining the weight for the waiting time for a subsequent elevator call allocation as a correction for a difference between a target transit time deviation and the determined average transit time deviation or for a difference between a target transit time and the determined average transit time.

In an implementation form of the second aspect, the means are further configured to perform obtaining the correction from a controller.

In an implementation form of the second aspect, the controller comprises a proportional-integral-derivative, PID, controller or a proportional-integral, PI, controller.

In an implementation form of the second aspect, the passenger traffic objective function comprises:

$$ω * WT + ( 1 - ω ) * TT , or \\ ω * WT + ( 1 - ω ) * TTD ,$$

in which WT denotes a sum of the waiting times, TT denotes a sum of the transit times, TTD denotes a sum of the times to destination, and ω denotes the obtained weight for the waiting time for the subsequent elevator call allocation.

In an implementation form of the second aspect, the at least one additional passenger traffic optimization objective further comprises at least one of a time to destination or a transit time, and an energy consumption.

In an implementation form of the second aspect, the at least one current passenger traffic indicator comprises at least a current average waiting time associated with a first controller configured to provide a first control signal and at least one of a current average transit time or a current average transit time deviation associated with a second controller configured to provide a second control signal. The determining of the weight for each of the at least two passenger traffic optimization objectives of the passenger traffic objective function comprises determining the weight for each of the at least two passenger traffic optimization objectives based on the first control signal and the second control signal.

According to a third aspect of the disclosure, a method is provided. The method comprises obtaining, by an apparatus for elevator call allocation in an elevator group of an elevator system, at least one current passenger traffic indicator related to the elevator group. The method further comprises determining, by the apparatus, a weight for each of at least two passenger traffic optimization objectives of a passenger traffic objective function based on the obtained at least one current passenger traffic indicator. The method further comprises optimizing, by the apparatus, the passenger traffic objective function using the determined weights. The method further comprises allocating, by the apparatus, a subsequent elevator call to an elevator car in the elevator group based on a result of the optimizing of the passenger traffic objective function.

In an implementation form of the first aspect, the at least two passenger traffic optimization objectives comprise a waiting time and at least one additional passenger traffic optimization objective.

In an implementation form of the third aspect, the weight for the at least one additional passenger traffic optimization objective comprises 1−ω in which ω denotes the weight for the waiting time.

In an implementation form of the third aspect, the at least one additional passenger traffic optimization objective comprises at least a time to destination.

In an implementation form of the third aspect, the at least one current passenger traffic indicator comprises a current average waiting time, AWTᵢ, and a current elevator car load factor, CLFᵢ. The obtaining of the at least one current passenger traffic indicator comprises determining a call allocation minimizing sum over passengers of at least terms of ωᵢ^{e}WT_j+(1−ωᵢ^{e})TTD_j for passengers j from an entrance floor and ωᵢ^{p}WT_k+(1−ωᵢ^{p})TTD_k for passengers k from non-entrance floors, in which i denotes an elevator call allocation instance, ωᵢ^{e} denotes a weight for the entrance, e, floor, ωᵢ^{p} denotes a weight for the non-entrance, p, floors, WT denotes the waiting time, and TTD denotes the time to destination. The obtaining of the at least one current passenger traffic indicator further comprises determining the average waiting time and the elevator car load factor based on the determined call allocation minimizing sum.

In an implementation form of the third aspect, the method further comprises determining a subsequent weight ω_{*}^{e} for the entrance floor and a subsequent weight ω_{*}^{p} for the non-entrance floors. The method further comprises determining updated weights for the entrance floor and the non-entrance floors to be used in the subsequent elevator call allocation using exponential smoothing:

$${ω}_{i + 1}^{e} := {ω}_{i}^{e} δ + {ω}_{*}^{e} ( 1 - δ ) \\ {ω}_{i + 1}^{p} := {ω}_{i}^{p} δ + {ω}_{*}^{p} ( 1 - δ )$$

in which δ denotes a parameter determining how slowly the weight is changed.

In an implementation form of the third aspect, the determining of the weight for each of the at least two passenger traffic optimization objectives of the passenger objective traffic function comprises determining the weight for the waiting time for the passengers from the entrance floor based on the current average waiting time and the current elevator car load factor using a first sigmoid function:

$${ω}_{*}^{e} = min \{ {γ}_{1} ( 1 - \frac{1}{1 + {e}^{- {α}_{1} ( {AWT}_{i} - {β}_{1} )}} ) , {γ}_{2} ( 1 - \frac{1}{1 + {e}^{- {α}_{2} ( {CLF}_{i} - {β}_{2} )}} ) \} .$$

The determining of the weight for each of the at least two passenger traffic optimization objectives of the passenger traffic objective function further comprises determining the weight for the waiting time for the passengers from the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, β and γ denote parameters specifying the shape of the sigmoid functions.

In an implementation form of the third aspect, the determining of the weight for each of the at least two passenger traffic optimization objectives of the passenger traffic objective function comprises determining the weight for the waiting time for the passengers from the entrance floor and the non-entrance floors based on the current average waiting time using a second sigmoid function:

$${ω}_{*}^{p} = {γ}_{3} ( 1 - \frac{1}{1 + {e}^{- {α}_{3} ( {AWT}_{i} - {β}_{3} )}} ) ,$$

in which α, β and γ denote parameters specifying the shape of the sigmoid function.

In an implementation form of the third aspect, at additional passenger traffic the least one optimization objective comprises a transit time.

In an implementation form of the third aspect, the obtaining of the at least one current passenger traffic indicator comprises determining at least one of an average transit time or an average transit time deviation after a current elevator call allocation.

In an implementation form of the third aspect, the method further obtaining short-term statistics about served elevator calls to facilitate the determining of at least one of the average transit time or the average transit time deviation.

In an implementation form of the third aspect, the determining of the weight for each of the at least two passenger traffic optimization objectives of the passenger traffic objective function comprises obtaining the weight for the waiting time for a subsequent elevator call allocation as a correction for a difference between a target transit time deviation and the determined average transit time deviation or for a difference between a target transit time and the determined average transit time.

In an implementation form of the third aspect, the method further comprises obtaining the correction from a controller.

In an implementation form of the third aspect, the controller comprises a proportional-integral-derivative, PID, controller or a proportional-integral, PI, controller.

In an implementation form of the third aspect, the passenger traffic objective function comprises:

$$ω * WT + ( 1 - ω ) * TT , or \\ ω * WT + ( 1 - ω ) * TTD ,$$

in which WT denotes a sum of the waiting times, TT denotes a sum of the transit times, TTD denotes a sum of the times to destination, and ω denotes the obtained weight for the waiting time for the subsequent elevator call allocation.

In an implementation form of the third aspect, the at least one additional passenger traffic optimization objective further comprises at least one of a time to destination or a transit time, and an energy consumption.

In an implementation form of the third aspect, the at least one current passenger traffic indicator comprises at least a current average waiting time associated with a first controller configured to provide a first control signal and at least one of a current average transit time or a current average transit time deviation associated with a second controller configured to provide a second control signal. The determining of the weight for each of the at least two passenger traffic optimization objectives of the passenger traffic objective function comprises determining the weight for each of the at least two passenger traffic optimization objectives based on the first control signal and the second control signal.

According to a fourth aspect of the disclosure, a computer program is provided. The computer program comprises instructions for causing an apparatus for elevator call allocation in an elevator group of an elevator system to perform at least the following: at least one current passenger traffic obtaining indicator related to the elevator group; determining a weight for each of at least two passenger traffic optimization objectives of a passenger traffic objective function based on the obtained at least one current passenger traffic indicator, the at least two passenger traffic optimization objectives comprising a waiting time, and at least one additional passenger traffic optimization objective; optimizing the passenger traffic objective function using the determined weights; and allocating a subsequent elevator call to an elevator car in the elevator group based on a result of the optimizing of the passenger traffic objective function.

At least some of the disclosed embodiments may allow adaptively and smoothly changing an objective function according to passenger traffic. This in turn may allow minimizing waiting times in all traffic situations compared to using a fixed objective function. At least some of the disclosed embodiments may allow adapting the objective function to the passenger traffic without passenger counting.

At least some of the disclosed embodiments may allow adaptively and smoothly changing the objective function according to the traffic while taking user preferences into consideration via a single transit time target parameter. Furthermore, changing a transit time target value or a transit time deviation target value may allow different passenger service levels.

Many of the features will be more readily appreciated as they become better understood by reference to the following detailed description considered in connection with the accompanying drawings.

### DESCRIPTION OF THE DRAWINGS

In the following, example embodiments are described in more detail with reference to the attached figures and drawings, in which:

FIG. 1 is a block diagram illustrating an elevator system;

FIG. 2 is a block diagram illustrating an apparatus for elevator call allocation according to an embodiment of the present disclosure;

FIG. 3 is a block diagram illustrating an apparatus for elevator call allocation with a feedback loop according to an embodiment of the present disclosure;

FIG. 4 is a diagram illustrating a sigmoid function according to an embodiment of the present disclosure;

FIG. 5 is a flow chart illustrating a method according to an embodiment of the present disclosure;

FIG. 6 is a diagram illustrating an overall concept of an energy consumption related embodiment; and

FIG. 7 is a diagram illustrating an example of a weight controller for the energy consumption related embodiment.

In the following, identical reference signs refer to identical or at least functionally equivalent features.

### DETAILED DESCRIPTION

In the following description, reference is made to the accompanying drawings, which form part of the disclosure, and in which are shown, by way of illustration, specific aspects in which the invention may be placed. It is understood that other aspects may be utilized, and structural or logical changes may be made without departing from the scope of the invention. The following detailed description, therefore, is not to be taken in a limiting sense, as the scope of the invention is defined in the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus or device is described based on functional units, a corresponding method may include a step performing the described functionality, even if such step is not explicitly described or illustrated in the figures. Further, it is understood that the features of the various example aspects described herein may be combined with each other, unless specifically noted otherwise.

The present disclosure is related to elevator call allocation with adaptive multi-objective optimization.

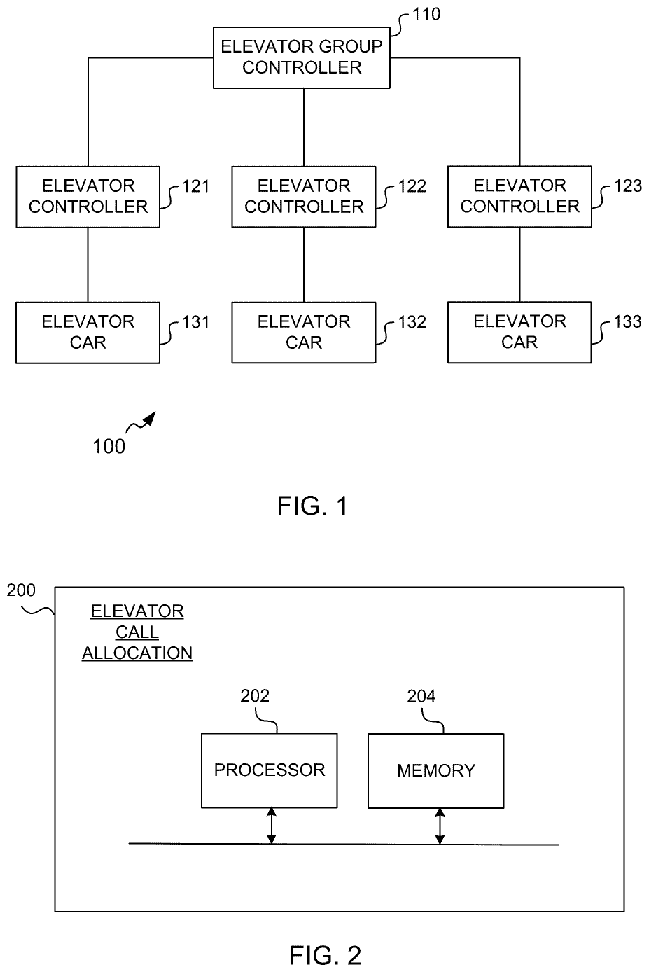

FIG. 1 is a block diagram illustrating an elevator system 100. The elevator system 100 comprises a set of elevator cars 131-133 controlled by respective elevator controllers 121-123. Each elevator controller 121-123 is connected to an elevator group controller 110. The elevator system 100 may include a destination control-based control system and/or a conventional (non-destination control-based) control system.

At least some of the disclosed embodiments may allow controlling a group of elevators such that a waiting time and a time to destination (and/or a transit time and/or a transit time deviation) of passenger objectives are simultaneously optimized so that their weights (describing their relative importance) are both adaptively and smoothly changed according to traffic. For example, the waiting time objective may be minimized during light passenger traffic, and as passenger traffic increases the weight of the time to destination (and/or the transit time and/or the transit time deviation) objective may be smoothly increased, and when the passenger traffic is close to or above a handling capacity of the elevator group, the focus may be mainly on minimizing the time to destination (and/or the transit time and/or the transit time deviation) objective.

In other words, at least some of the disclosed embodiments may allow adjusting an objective function based on the passenger traffic situation.

At least some of the disclosed embodiments may allow transforming the waiting time and time to destination (and/or transit time and/or the transit time deviation) objectives into a single-objective problem by using a weighted sum method. However, the disclosure is not restricted to this particular scalarization method. Instead, any V: [symbol] ²→ [symbol] parametrized family of value functions: V_{ω}: [symbol] ²→ [symbol] (where ω∈[0,1] controls the relative importance of the time to destination (and/or the transit time and/or the transit time deviation) compared to the waiting time) may be used.

At least some of the disclosed embodiments may allow the adjusting of the weighs of the objectives without passenger-counting based traffic forecasts.

At least some of the disclosed embodiments may allow a control loop mechanism (e.g., in an elevator group controller) that adjust the weights of objectives between call allocations based on a difference between a desired target level for a transit time deviation and a measured transit time deviation or a desired target level for a transit time and a measured transit time. This approach may allow providing different service level profiles. For example, if a transit time target or a transit time deviation target is set to zero, the apparatus 200 may optimize the transit time or transit time deviation or time to destination in all traffic situations, whereas for a large transit time target value or a large transit time deviation target value, the apparatus 200 may optimize the waiting time, and for a small value the objective function may, e.g., change according to passenger traffic.

At least some of the disclosed embodiments may allow providing building/facility managers an easy and understandable way (having only one parameter) to regulate the passenger service level according to their preferences.

At least some of the disclosed embodiments may allow the objective function to be implemented such that during light traffic, user preferences may be considered and optimized, but during heavy traffic, focus may be on maximizing handling capacity independent of user preferences.

At least some of the disclosed embodiments may allow reducing energy consumption while still allowing at least an adequate performance.

At least some of the disclosed embodiments may allow saving running energy at least as much as the operation of switching an elevator off or putting an elevator into standby mode, while still keeping all elevators available to the passengers and being able to react to changes sudden in passenger demand. Furthermore, at least some of the disclosed embodiments may not require the additional intelligence of detecting off-peak hours to switch off elevators. At least some of the disclosed embodiments may further allow decreasing the distance travelled by the elevators, and hence, decreasing the wear of equipment.

At least some of the disclosed embodiments may work also in destination control systems and may allow taking into account at least two different service level objectives.

At least some of the disclosed embodiments may work without requiring estimates of traffic.

At least some of the disclosed embodiments may allow taking preferences of stakeholders (such as building managers) into account, e.g., by tuning the target levels for average waiting time and average transit time deviation.

It is to be noted that the time to destination is a sum of the waiting time and the transit time. Accordingly, the waiting time objective and the time to destination objective are correlated. Therefore, in some embodiments a transit time (or transit time deviation) objective may be used instead of a time to destination objective.

Next, example embodiments of an apparatus 200 for elevator call allocation in an elevator group of an elevator system are described based on FIG. 2. Some of the features of the described units are optional features which may provide further advantages.

FIG. 2 is a block diagram illustrating the apparatus 200 for elevator call allocation in an elevator group of an elevator system, in accordance with an example embodiment. In at least some embodiments, the elevator system may comprise the elevator system 100 of FIG. 1.

The apparatus 200 comprises at least one processor or a processing unit 202, and at least one memory 204 including computer program code and coupled to the at least one processor 202, which may be used to implement the functionalities described later in more detail. The apparatus 200 may also include other elements not shown in FIG. 2.

In an example embodiment, the apparatus 200 may be comprised at least partly in an elevator group controller controlling a plurality of elevator cars, such as in the elevator group controller 110 of FIG. 1. In another example embodiment, the apparatus 200 may be comprised at least partly in a cloud-based service and at least some remaining parts of the apparatus 200 may be comprised in the elevator group controller 110.

Although the apparatus 200 is depicted to include only one processor 202, the apparatus 200 may include more processors. In an embodiment, the memory 204 is capable of storing instructions, such as an operating system and/or various applications. Furthermore, the memory 204 may include a storage that may be used to store, e.g., at least some of the information and data used in the disclosed embodiments.

Furthermore, the processor 202 is capable of executing the stored instructions. In an embodiment, the processor 202 may be embodied as a multi-core processor, a single core processor, or a combination of one or more multi-core processors and one or more single core processors. For example, the processor 202 may be embodied as one or more of various processing devices, such as a coprocessor, a microprocessor, a controller, a digital signal processor (DSP), a processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like. In an embodiment, the processor 202 may be configured to execute hard-coded functionality. In an embodiment, the processor 202 is embodied as an executor of software instructions, wherein the instructions may specifically configure the processor 202 to perform the algorithms and/or operations described herein when the instructions are executed.

The at least one memory 204 may be embodied as one or more volatile memory devices, one or more non-volatile memory devices, and/or a combination of one or more volatile memory devices and non-volatile memory devices. For example, the at least one memory 204 may be embodied as semiconductor memories (such as mask ROM, PROM (programmable ROM), EPROM (erasable PROM), flash ROM, RAM (random access memory), etc.).

The at least one memory 204 and the computer program code are configured to, with the at least one processor 202, cause the apparatus 200 at least to perform obtaining at least one current passenger traffic indicator related to the elevator group.

The at least one memory 204 and the computer program code are further configured to, with the at least one processor 202, cause the apparatus 200 at least to perform determining a weight for each of at least two passenger traffic optimization objectives of a passenger traffic objective function based on the obtained at least one passenger current traffic indicator. For example, the at least two passenger traffic optimization objectives may comprise a waiting time and at least one additional passenger traffic optimization objective.

The at least one memory 204 and the computer program code are further configured to, with the at least one processor 202, cause the apparatus 200 at least to perform optimizing the passenger traffic objective function using the determined weights.

The at least one memory 204 and the computer program code are further configured to, with the at least one processor 202, cause the apparatus 200 at least to perform allocating a subsequent elevator call to an elevator car 131, 132, 133 in the elevator group based on a result of the optimizing of the passenger traffic objective function.

At least in some embodiments, the weight for the at least one additional passenger traffic optimization objective may comprise 1−ω in which ω denotes the weight for the waiting time. When there are more than one additional passenger traffic optimization objective, their sum may comprise 1−ω. In other words, a weighted sum method (or any other scalarization method in which the relative importance of objectives is expressed by weights) may be utilized, such that the weight (ω) of the waiting time objective used in a current elevator call allocation may be determined based on a result of a previous elevator call allocation, and the weight of the time to destination (or the transit time) is 1−ω.

In a first implementation example, the at least one additional passenger traffic optimization objective may comprise at least a time to destination. For example, the weights of the waiting time and time to destination objectives may be adjusted such that the focus is mainly on minimizing the weight of the waiting time objective during light passenger traffic, the weight of the time to destination objective is increased as traffic intensity increases, and when the traffic is close to a handling capacity of the elevator group, the focus is mainly on minimizing the weight of the time to destination objective.

Further in the first implementation example, the at least one current passenger traffic indicator may comprise a current average waiting time (AWTᵢ) and a current elevator car load factor (CLFᵢ).

For example, separate weights may be maintained for elevator calls from entrance floors (or levels) and for elevator calls from other floors. At least in some embodiments, average waiting times and elevator car load factors computed in each allocation may be used as a proxy of a prevailing passenger traffic situation, to compute new weights to be used in a next elevator call allocation.

Accordingly, the obtaining of the at least one current passenger traffic indicator may comprise determining (in an i^{th} elevator call allocation) a call allocation minimizing sum over passengers of at least terms ωᵢ^{e}WT_j+1−ωᵢ^{e}TTD_j for passengers j from an entrance floor and ωᵢ^{p}WT_k+1−ωᵢ^{p}TTD_k for passengers k from non-entrance floors, in which i denotes an elevator call allocation instance, ωᵢ^{e} denotes a weight for the entrance (e) floor, ωᵢ^{p} denotes a weight for the non-entrance (p) floors, WT denotes the waiting time, and TTD denotes the time to destination. For example, genetic algorithms may be used for this. At least in some embodiments, the minimizing sum may also have other terms, such as penalty terms.

The obtaining of the at least one current passenger traffic indicator may further comprise determining the average waiting time and the elevator car load factor based on the determined call allocation minimizing sum.

Further in the first implementation example, the at least one memory 204 and the computer program code may be further configured to, with the at least one processor 202, cause the apparatus 200 at least to perform determining a subsequent (or new) weight ω_{*}^{e} for the entrance floor and a subsequent (or new) weight ω_{*}^{p} for the non-entrance floors. Then, the at least one memory 204 and the computer program code may be further configured to, with the at least one processor 202, cause the apparatus 200 at least to perform determining updated weights for the entrance floor and the non-entrance floors to be used in the subsequent elevator call allocation using exponential smoothing, e.g., as follows:

$${ω}_{i + 1}^{e} := {ω}_{i}^{e} δ + {ω}_{*}^{e} ( 1 - δ )$$

$${ω}_{i + 1}^{p} := {ω}_{i}^{p} δ + {ω}_{*}^{p} ( 1 - δ )$$

in which δ denotes a parameter determining how slowly the weight is changed, i.e., the importance of history versus a latest value. At least in some embodiments, the subsequent (or new) weight ω_{*}^{e} for the entrance floor and the subsequent (or new) weight ω_{*}^{p} for the non-entrance floors may have the same value.

In other words, the weights being updated using the exponential smoothing may comprise a weight being set to a weighted average of a current weight and a proposed new weight.

Further in the first implementation example, the determining of the weight for each of the at least two passenger traffic optimization objectives of the passenger traffic objective function may comprise determining (after the i^{th} elevator call allocation) the weight for the waiting time for the passengers from the entrance floor based on the current average waiting time (i.e., the average waiting time AWTᵢ of the i^{th} elevator call allocation) and the current elevator car load factor (i.e., the elevator car load factor CLFᵢ of the i^{th} elevator call allocation) using a first sigmoid function:

$${ω}_{*}^{e} = min \{ {γ}_{1} ( 1 - \frac{1}{1 + {e}^{- {α}_{1} ( A W {T}_{i} - {β}_{1} )}} ) , {γ}_{2} ( 1 - \frac{1}{1 + {e}^{- {α}_{2} ( C L {F}_{i} - {β}_{2} )}} ) \} .$$

In addition, the determining of the weight for each of the at least two passenger traffic optimization objectives of the passenger traffic objective function may further comprise determining (after the i^{th} elevator call allocation) the weight for the waiting time for the passengers from the non-entrance floors based on the current average waiting time (i.e., the average waiting time AWTᵢ of the i^{th} elevator call allocation) using a second sigmoid function:

$${ω}_{*}^{p} = {γ}_{3} ( 1 - \frac{1}{1 + {e}^{- {α}_{3} ( A W {T}_{i} - {β}_{3} )}} ) ,$$

Herein, α, β and γ denote parameters specifying the shape of the (first and/or second) sigmoid functions.

Alternatively, the determining of the weight for each of the at least two passenger traffic optimization objectives of the passenger traffic objective function may comprise determining the weight for the waiting time for the passengers from the entrance floor and the non-entrance floors based on the current average waiting time using the second sigmoid function:

$${ω}_{*}^{p} = {γ}_{3} ( 1 - \frac{1}{1 + {e}^{- {α}_{3} ( A W {T}_{i} - {β}_{3} )}} ) ,$$

in which α, β and γ denote parameters specifying the shape of the sigmoid function, as described above.

The parameters α, β and γ of the sigmoid functions may be determined, e.g., based on simulations, statistical methods, or machine learning methods. Alternatively, the sigmoid shape may be replaced with functions learned from data.

Diagram 400 of FIG. 4 illustrates an example sigmoid function (as a function of the average waiting time) according to an embodiment of the present disclosure. In the example of FIG. 4, α=0.2, β=40, and γ=0.75.

In a second implementation example, the at least one additional passenger traffic optimization objective may comprise a transit time (and/or implicitly a transit time deviation). For example, the weights of the waiting time and transit time objectives may be adjusted such that the focus is mainly on minimizing the weight of the waiting time objective during light passenger traffic, the weight of the transit time objective is increased as traffic intensity increases, and when the traffic is close to a handling capacity of the elevator group, the focus is mainly on minimizing the time to destination objective. In the time to destination minimization, both the waiting time and the transit time may have the same weight, and thus the lower limit for ω may be, e.g., 0.5.

Further in the second implementation example, the obtaining of the at least one current passenger traffic indicator may comprise determining an average transit time and/or an average transit time deviation after a current elevator call allocation. In other words, at the end of an elevator call allocation, the average transit time deviation may be calculated. Herein, the term “transit time deviation” is used to refer to a normal transit time minus an ideal transit time, and the term “ideal transit time” is used to refer to a transit time without any stops between origin and destination floors of an elevator call. Using the transit time deviation instead of the normal transit time allows the same deviation value to be used for both low-rise and high-rise buildings with express floors. Also, when using the transit time deviation, both objectives are quite closely in a same scale, which means that there is no need to scale the objectives to a [0-1] range.

Further in the second implementation example, the at least one memory 204 and the computer program code may be further configured to, with the at least one processor 202, cause the apparatus 200 at least to perform obtaining short-term statistics about served elevator calls to facilitate the determining of the average transit time and/or the average transit time deviation.

In other words, as the average transit time or the average transit time deviation can change from one allocation to another, to prevent the weight of the waiting time objective changing too much, the short-term statistics about the served calls may be provided to the apparatus 200 and used in the average transit time or average transit time deviation calculation (but not used in the objective function). In the objective function, normal transit time may be used.

Further in the second implementation example, the determining of the weight for each of the at least two passenger traffic optimization objectives of the passenger traffic objective function may comprise obtaining the weight for the waiting time for a subsequent elevator call allocation as a correction for a difference between a target transit time deviation and the determined average transit time deviation or for a difference between a target transit time and the determined average transit time. For example, a controller 310, as such a proportional-integral-derivative (PID) controller or a proportional-integral (PI) controller discussed in more detail below may calculate an error as the difference between a desired target value for the transit time deviation and the determined/measured (average) transit time deviation and apply a correction via a new weight of the waiting time objective for the next allocation.

Further in the second implementation example, the at least one memory 204 and the computer program code may be further configured to, with the at least one processor 202, cause the apparatus 200 to obtain the correction from the controller 310. The short-term statistics may be recorded in a memory when calls are being served.

In other words, to take user preferences into account and to provide controllability over passenger service level, a feedback loop formed with the controller 310 may be used. At least in some embodiments, the controller 310 may be included, e.g., in the apparatus 200 or the elevator group controller 110 (not shown in FIGS. 1 to 2). The controller 310 may adjust the value of ω based on the difference between the measured or determined (average) transit time deviation and the target transit time deviation or the difference between the measured or determined (average) transit time and the target transit time. Here, the target transit time deviation represents user preferences.

Further in the second implementation example, the passenger traffic objective function used in the elevator call allocation may comprise, e.g.:

$$ω * W T + ( 1 - ω ) * TT , or$$

$$ω * WT + ( 1 - ω ) * T T D ,$$

in which WT denotes a sum of the waiting times, TT denotes a sum of the transit times, TTD denotes a sum of the times to destination, and ω denotes the obtained weight for the waiting time for the subsequent elevator call allocation. For example, the value of ω may come from the PID controller 310, and the value of ω may change from one elevator call allocation to another.

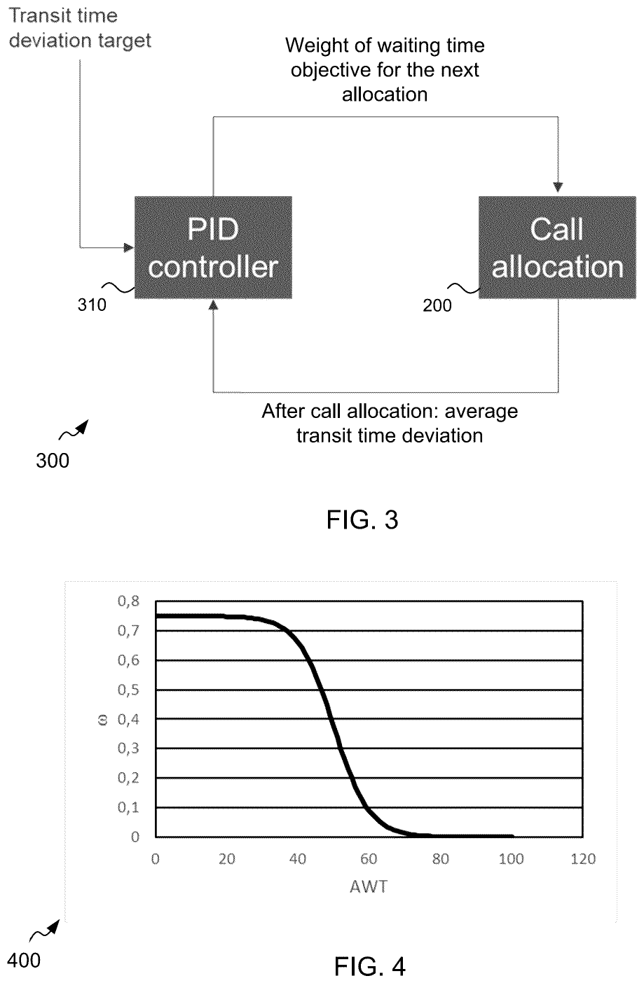

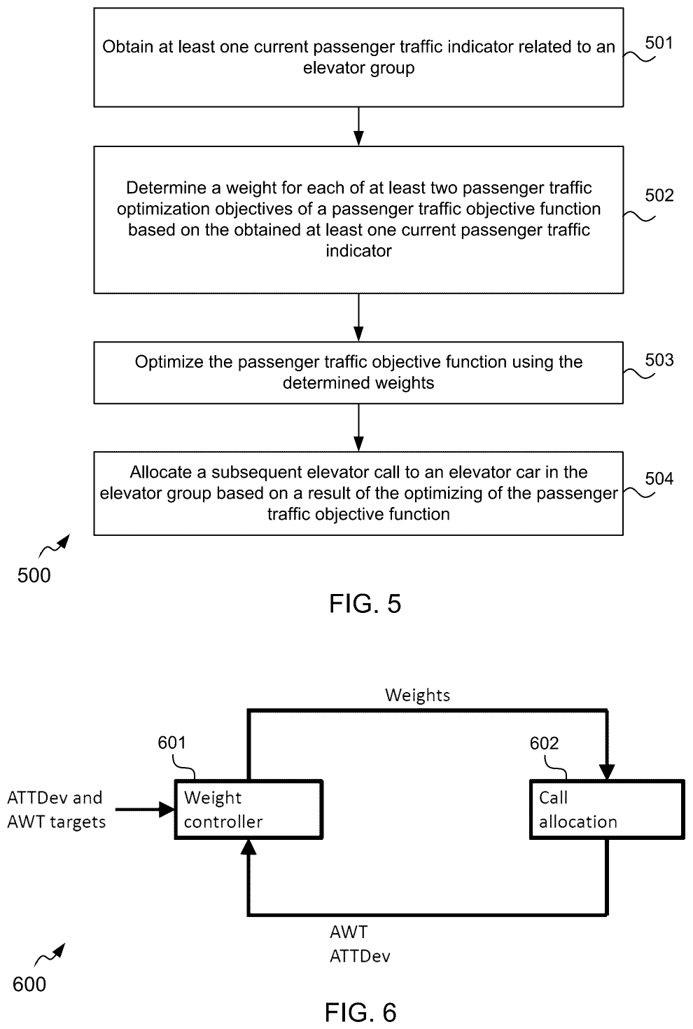

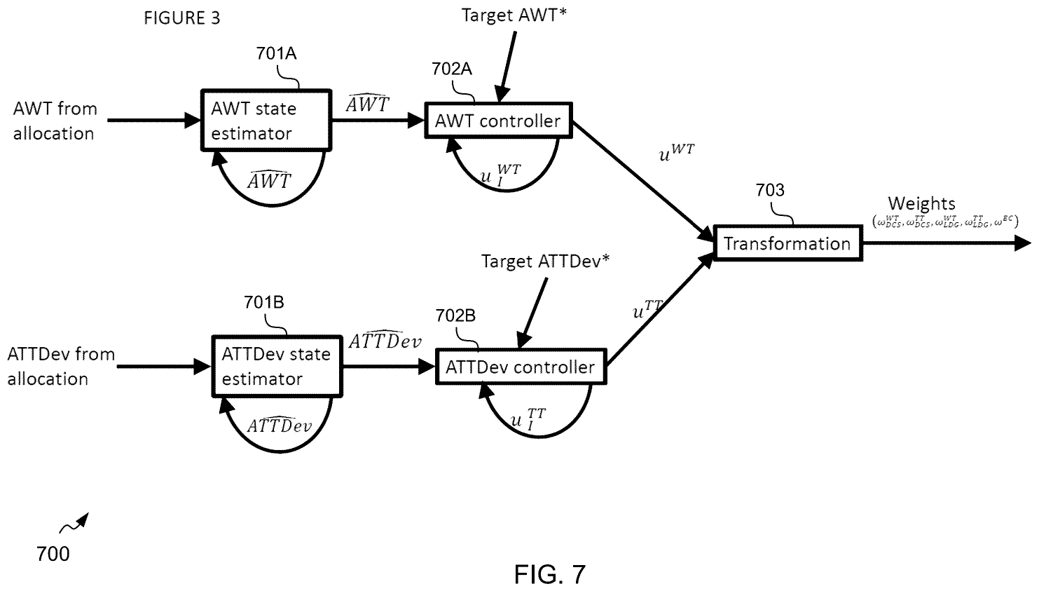

Diagram 300 of FIG. 3 illustrates the apparatus 200 for elevator call allocation with the PID controller 310, as discussed above.

Further in the second implementation example, different transit time target levels or transit time deviation target levels may lead to different service level profiles. Thus, the elevator system 100 may be configured with the help of the transit time target to optimize;
1) the time to destination by setting the transit time deviation target or the transit time target set to zero;
2) the waiting time by setting the transit time deviation target or the transit time target to a large value; or
3) the waiting time during light traffic and the time to destination during heavy traffic by setting the transit time deviation target or the transit time target set to a small value (e.g., to 20, although this is dependent on building and elevator parameters).

In a third implementation example, the at least one additional passenger traffic optimization objective may comprise a time to destination or a transit time, and an energy consumption. Furthermore, the at least one current passenger traffic indicator may comprise at least a current average waiting time (AWT) associated with a first controller configured to provide a first control signal, and a current average transit time and/or a current average transit time deviation (ATTDev) associated with a second controller configured to provide a second control signal. The determining of the weight for each of the at least two passenger traffic optimization objectives of the passenger traffic objective function may comprise determining the weight for least each of the at two passenger traffic optimization objectives based on the first control signal and the second control signal.

The overall concept of the third implementation example is illustrated in diagram 600 of FIG. 6. Similar to the first and second implementation examples, there may be a preconfigured target level(s) defined for the passenger traffic indicator(s). Each call allocation 602 may be performed by optimizing an objective function where the importance of the objectives may be determined by weight coefficients or weights. The values computed for the performance indicator(s) in the selected allocation solution may be fed to a separate weight controller module 601. The weight controller module 601 may be configured to monitor the difference between the levels computed in allocation 602 and the target levels. For example, weights may be defined for energy consumption, waiting time of destination calls, waiting time of landing calls, transit time of destination calls, and/or transit time of car calls.

In the third implementation example call allocation 602 may be triggered, e.g., when a call is registered (immediate allocation) or at a specific frequency (continuous allocation). A genetic algorithm, or other suitable optimization method may be used to minimize, e.g., a loss function of a weighted sum of the form:

$${L}_{ω} ( x ) := {ω}_{D C S}^{W T} D C S W T ( x ) + {ω}_{D C S}^{T T} D C S T T ( x ) + {ω}_{L D G}^{W T} L D G W T ( x ) + {ω}_{L D G}^{T T} L D G T T ( x ) + {ω}^{E C} E C ( x ) + Penalty ( x )$$

in which for a selected solution x:
DCSWT(x) represents a sum of waiting times of passengers giving destination calls,
DCSTTT(x) represents a sum of transit times of passengers giving destination calls.
LDGWT(x) represents a sum of waiting times of passengers giving landing calls,
LDGTT(x) represents a sum of transit times of passengers giving landing calls (/car calls),
EC(x) represents a total energy consumption, and
Penalty(x) may contain other terms.

A weight vector ω=(ω_{DCS}^{WT},ω_{DCS}^{TT},ω_{LDG}^{WT},ω_{LDG}^{TT},ω^{EC}) may contain the weight coefficients that control the importance of a respective criteria in the loss function.

Alternatively, a loss function family of the form:

$${L}_{ω} ( x ) := {f}_{ω} ( D C S W T ( x ) , D C S T T ( x ) , LDGWT ( x ) , L D G T T ( x ) , E C ( x ) , Penalty ( x ) ) ,$$

may be used,
in which a weight vector ω may control the relative importance of each objective.

Energy consumption EC(x) caused by a candidate allocation solution x may be calculated, e.g., as a sum of energy consumptions of cycles in candidate routes implied by the allocation. Alternatives for computing the cycle-specific energy consumption may include, e.g.:
the distance traveled: simple to compute without requiring elevator group specific energy models; and
running energy consumption computed based on a model of an elevator system as a function of distance and load, with or without a change in potential energy.

An example of a weight controller for the above energy consumption related embodiment is illustrated in diagram 700 of FIG. 7.

The passenger traffic indicator indicators (AWT, ATTDev) calculated in call allocation 601 may be fed to state estimators 701A, 701B configured to smooth the raw values received from allocation 601. Similar to the second implementation example, besides the calls that are currently in the system, these may also contain a short-term history of calls from, e. g., last 2 minutes.

The state estimates in turn may be fed to controllers 702A, 702B that produce a control signal u∈[0,1], in which a high value of u indicates that more weight be should on put a corresponding indicator/objective. In a transformation block 703, the control signals from the indicator-specific controllers 702A, 702B may be combined into the weights that are used in allocation 601.

The state estimator 701A, 701B may comprise, e.g., an exponential smoother, in which a new estimate is a weighted average of a current estimate and a new value obtained from allocation:

$$← α AWT + ( 1 - α )$$

in which α represents a parameter controlling how aggressively the estimator 701A, 701B reacts to new observations.

The controller 702A, 702B may comprise, e. g., a PI controller, i.e., at every weight update step the control signal u^{WT} may be computed, e.g., as follows:

$$ϵ ← - AW {T}^{*}$$

$$ϵ ← max ( {ϵ}_{min} , min ( {ϵ}_{max} , ϵ ) )$$

$${u}_{P}^{W T} ← {k}_{P} ϵ$$

$${u}_{P}^{W T} ← max ( 0 , min ( 1 , {u}_{P}^{W T} ) )$$

$${u}_{I}^{W T} ← {u}_{I}^{W T} + {k}_{i} ϵ$$

$${u}_{I}^{W T} ← max ( 0 , min ( 1 , {u}_{I}^{W T} ) )$$

$${u}^{W T} ← {u}_{P}^{W T} + {u}_{I}^{W T}$$

$${u}^{W T} ← max ( 0 , min ( 1 , {u}^{W T} ) )$$

in which ϵ represents a difference between estimate and target (capped between a min and max value), parameters kₗ, kₚ represent gains of an integrator and a proportional term, respectively, up and uₗ^{WT} represent proportional and integrator terms of the PI controller (capped between 0 and 1, or other minimum/maximum values), and u^{WT} represents a final WT control signal that is fed to the transformation block 703.

The transformation block 703 may map the control signals u_{WT}, u_{TT} into the weights ω. It may comprise, e.g.:

$${ω}_{D C S}^{W T} := {u}^{T T} + {u}^{W T} ( 1 - {u}^{T T} )$$

$${ω}_{D C S}^{T T} := {u}^{T T}$$

$${ω}^{E C} := ( 1 - {u}^{W T} ) \times ( 1 - {u}^{T T} )$$

$${ω}_{L D G}^{W T} := ( 1 - {ω}^{E C} )$$

$${ω}_{L D G}^{T T} := ( 1 - {ω}^{E C} ) \times ( 1 - {w}_{c o n s tant}^{W T} )$$

in which w_{constant}^{WT} represents a configuration parameter defining the relative weights between waiting and transit of non-destination control system passengers.

Ignoring the LDG weights, the rationale of this transformation is that time to destination as a proxy for handling capacity may have the highest priority, so that if transit time deviation is above target, the control signal u^{TT} approaches 1 and the weights ω_{DCS}^{WT}, ω_{DCS}^{TT} approach 1 and ω^{EC} approaches 0, corresponding to full time to destination optimization. If transit time deviation target is achieved without full TTD optimization (i.e., u^{TT}<1), the WT control signal u^{WT} may be used to decide the relative importance between waiting time and energy consumption. The landing calls may be handled slightly differently since the system may not be able to monitor the realized waiting times and times to destination (if TT improves at the cost of WT, this may not be visible to the user). Furthermore, it may be that TTD is not as good a proxy for handling capacity with LDG calls, and thus it is not necessarily best to use full time to destination optimization in high traffic.

FIG. 5 illustrates an example flow chart of a method 500, in accordance with an example embodiment.
At operation 501, the apparatus 200 for elevator call allocation in the elevator group of the elevator system 100 obtains at least one current passenger traffic indicator related to the elevator group.
At operation 502, the apparatus 200 determines a weight for each of at least two passenger traffic optimization objectives of a passenger traffic objective function based on the obtained at least one current passenger traffic indicator.
At operation 503, the apparatus 200 optimizes the passenger traffic objective function using the determined weights.
At operation 504, the apparatus 200 allocates a subsequent elevator call to an elevator car 131, 132, 133 in the elevator group based on a result of the optimizing of the passenger traffic objective function.

The method 500 may be performed by the apparatus 200 of FIG. 2. The operations 501-504 can, for example, be performed by the at least one processor 202 and the at least one memory 204. Further features of the method 500 directly result from the functionalities and parameters of the apparatus 200, and thus are not repeated here. The method 500 can be performed by computer program(s).

The apparatus 200 may comprise means for performing at least one method described herein. In an example, the means may comprise the at least one processor 202, and the at least one memory 204 including program code configured to, when executed by the at least one processor 202, cause the apparatus 200 to perform the method.

The functionality described herein can be performed, at least in part, by one or more computer program product components such as software components. According to an embodiment, the apparatus 200 may comprise a processor or processor circuitry, such as for example a microcontroller, configured by the program code when executed to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAS), Program-specific Integrated Circuits (ASICs), Program-specific Standard Products (ASSPs), System-on-a-chip systems (SOCs), Complex Programmable Logic Devices (CPLDs), and Graphics Processing Units (GPUS).

Any range or device value given herein may be extended or altered without losing the effect sought. Further, any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed examples of implementing the claims and other as equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of example embodiments. Although various embodiments have been described above with a certain degree of particularity, or with reference to one or more individual embodiments, those skilled in the art could make numerous alterations to the disclosed embodiments without departing from the scope of this specification.

1. An apparatus for elevator call allocation in an elevator group of an elevator system, the apparatus comprising:
at least one processor; and
at least one memory including computer program code;
the at least one memory and the computer program code configured to, with the at least one processor, cause the apparatus at least to perform:
obtaining at least one current passenger traffic indicator related to the elevator group;
determining a weight for each of at least two passenger traffic optimization objectives of a passenger traffic objective function based on the obtained at least one current passenger traffic indicator;
optimizing the passenger traffic objective function using the determined weights; and
allocating a subsequent elevator call to an elevator car in the elevator group based on a result of the optimizing of the passenger traffic objective function.

2. The apparatus according to claim 1, wherein the at least two passenger traffic optimization objectives comprise a waiting time and at least one additional passenger traffic optimization objective.

3. The apparatus according to claim 2, wherein the weight for the at least one additional passenger traffic optimization objective comprises 1−ω in which ω denotes the weight for the waiting time.

4. The apparatus according to claim 2, wherein the at least one additional passenger traffic optimization objective comprises at least a time to destination.

5. The apparatus according to claim 4, wherein the at least one current passenger traffic indicator comprises a current average waiting time, AWTᵢ, and a current elevator car load factor, CLFᵢ, and the obtaining of the at least one current passenger traffic indicator comprises:
determining a call allocation minimizing sum over passengers of at least terms ωᵢ^{e}WT_j+(1−ωᵢ^{e})TTD_j for passengers j from an entrance floor and ωᵢ^{p}WT_k+(1−ωᵢ^{p})TTD_k for passengers k from non-entrance floors, in which i denotes an elevator call allocation instance, ωᵢ^{e} denotes a weight for the entrance, e, floor, ωᵢ^{p} denotes a weight for the non-entrance, p, floors, WT denotes the waiting time, and TTD denotes the time to destination; and
determining the average waiting time and the elevator car load factor based on the determined call allocation minimizing sum.

6. The apparatus according to claim 5, wherein the at least one memory and the computer program code are further configured to, with the at least one processor, cause the apparatus at least to perform:
determining a subsequent weight ω_{*}^{e} for the entrance floor and a subsequent weight ω_{*}^{p} for the non-entrance floors; and
determining updated weights for the entrance floor and the non-entrance floors to be used in the subsequent elevator call allocation using exponential smoothing:
$${ω}_{i + 1}^{e} := {ω}_{i}^{e} δ + {ω}_{*}^{e} ( 1 - δ )$$
$${ω}_{i + 1}^{p} := {ω}_{i}^{p} δ + {ω}_{*}^{p} ( 1 - δ )$$
in which δ denotes a parameter determining how slowly the weight is changed.

7. The apparatus according to claim 6, wherein the determining of the weight for each of the at least two passenger traffic optimization objectives of the passenger traffic objective function comprises:
determining the weight for the waiting time for the passengers from the entrance floor based on the current average waiting time and the current elevator car load factor using a first sigmoid function:
$${ω}_{*}^{e} = min \{ {γ}_{1} ( 1 - \frac{1}{1 + {e}^{- {α}_{1} ( A W {T}_{i} - {β}_{1} )}} ) , {γ}_{2} ( 1 - \frac{1}{1 + {e}^{- {α}_{2} ( C L {F}_{i} - {β}_{2} )}} ) \} ;$$
and
determining the weight for the waiting time for the passengers from the non-entrance floors based on the current average waiting time using a second sigmoid function:
$${ω}_{*}^{p} = {γ}_{3} ( 1 - \frac{1}{1 + {e}^{- {α}_{3} ( A W {T}_{i} - {β}_{3} )}} ) ,$$
in which α, β and γ denote parameters specifying the shape of the sigmoid functions.

8. The apparatus according to claim 6, wherein the determining of the weight for each of the at least two passenger traffic optimization objectives of the passenger traffic objective function comprises:
determining the weight for the waiting time for the passengers from the entrance floor and the non-entrance floors based on the current average waiting time using a second sigmoid function:
$${ω}_{*}^{p} = {γ}_{3} ( 1 - \frac{1}{1 + {e}^{- {α}_{3} ( A W {T}_{i} - {β}_{3} )}} ) ,$$
in which α, β and γ denote parameters specifying the shape of the sigmoid function.

9. The apparatus according to claim 2, wherein the at least one additional passenger traffic optimization objective comprises a transit time.

10. The apparatus according to claim 9, wherein the obtaining of the at least one current passenger traffic indicator comprises determining at least one of an average transit time or an average transit time deviation after a current elevator call allocation.

11. The apparatus according to claim 10, wherein the at least one memory and the computer program code are further configured to, with the at least one processor, cause the apparatus at least to perform:
obtaining short-term statistics about served elevator calls to facilitate the determining of the at least one of the average transit time or the average transit time deviation.

12. The apparatus according to claim 10, wherein the determining of the weight for each of the at least two passenger traffic optimization objectives of the passenger traffic objective function comprises:
obtaining the weight for the waiting time for a subsequent elevator call allocation as a correction for a difference between a target transit time deviation and the determined average transit time deviation or for a difference between a target transit time and the determined average transit time.

13. The apparatus according to claim 12, wherein the at least one memory and the computer program code are further configured to, with the at least one processor, cause the apparatus to obtain the correction from a controller.

14. The apparatus according to claim 13, wherein the controller comprises a proportional-integral-derivative, PID, controller or a proportional-integral, PI, controller.

15. The apparatus according to claim 13, wherein the passenger traffic objective function comprises:
$$ω * W T + ( 1 - ω ) * TT , or$$
$$ω * WT + ( 1 - ω ) * T T D ,$$
in which WT denotes a sum of the waiting times, TT denotes a sum of the transit times, TTD denotes a sum of the times to destination, and ω denotes the obtained weight for the waiting time for the subsequent elevator call allocation.

16. The apparatus according to claim 2, wherein the at least one additional passenger traffic optimization objective comprises at least one of a time to destination or a transit time, and an energy consumption.

17. The apparatus according to claim 16, wherein the at least one current passenger traffic indicator comprises at least a current average waiting time associated with a first controller configured to provide a first control signal and at least one of a current average transit time or a current average transit time deviation associated with a second controller configured to provide a second control signal, wherein the determining of the weight for each of the at least two passenger traffic optimization objectives of the passenger traffic objective function comprises determining the weight for each of the at least two passenger traffic optimization objectives based on the first control signal and the second control signal.

18. A method, comprising:
obtaining, by an apparatus for elevator call allocation in an elevator group of an elevator system, at least one current passenger traffic indicator related to the elevator group;
determining, by the apparatus, a weight for each of at least two passenger traffic optimization objectives of a passenger traffic objective function based on the obtained at least one current passenger traffic indicator;
optimizing, by the apparatus, the passenger traffic objective function using the determined weights; and
allocating, by the apparatus, a subsequent elevator call to an elevator car in the elevator group based on a result of the optimizing of the passenger traffic objective function.

19. A non-transitory computer readable medium storing a computer program comprising instructions for causing an apparatus for elevator call allocation in an elevator group of an elevator system to perform at least the following:
obtaining at least one current passenger traffic indicator related to the elevator group;
determining a weight for each of at least two passenger traffic optimization objectives of a passenger traffic objective function based on the obtained at least one current passenger traffic indicator;
optimizing the passenger traffic objective function using the determined weights; and
allocating a subsequent elevator call to an elevator car in the elevator group based on a result of the optimizing of the passenger traffic objective function.

20. The apparatus according to claim 3, wherein the at least one additional passenger traffic optimization objective comprises at least a time to destination.
